(19) United States
(12) Patent Application Publication
(10) Pub. No.: US 2007/0229300 A1
(43) Pub. Date: Oct. 4, 2007

(54) Remote control signal transfer system

(76) Inventors: Tsuyoshi Masato, Kanagawa (JP); Hisao Sakurai, Saitama (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(21) Appl. No.: 11/716,812

(22) Filed: Mar. 12, 2007

(30) Foreign Application Priority Data
Mar. 17, 2006 (JP) 2006-075620

(51) Int. Cl. G08C 19/00

(52) U.S. Cl. 340/825.69; 340/825.72; 398/106

(57) ABSTRACT

A remote control signal transfer system for transferring a remote control signal sent by a remote control toward a controlled apparatus via a transmission medium, the system including: one or more remote control signal reception devices each installed at a separate place; and one or more remote control signal reconstruction devices each installed for a separate one of the one or more controlled apparatuses. Each remote control signal reception devices subjects a remote control signal obtained from a remote control receiving section to sampling, and transmits resultant data to the transmission medium. Each more remote control signal reconstruction devices composes the remote control signals received from any one or more of the remote control signal reception devices via the transmission medium into a single composed signal, and outputs the single composed signal to the corresponding controlled apparatus via a single remote control transmitting section.

### CROSS REFERENCES TO RELATED APPLICATIONS

The present invention contains subject matter related to Japanese Patent Application JP 2006-075620, filed in the Japanese Patent Office on Mar. 17, 2006, the entire contents of which being incorporated herein by reference.

### BACKGROUND OF THE INVENTION

1. Field of the Invention

The present invention relates to a remote control signal transfer system for transferring a remote control signal transmitted by a remote control to an apparatus to be controlled at a separate place. In particular, the present invention relates to a remote control signal transfer system that involves reception of remote control signals from a plurality of remote controls and transfer of the remote control signals to a plurality of controlled apparatuses.

More particularly, the present invention relates to a remote control signal transfer system for, in a system including a plurality of remote controls and a plurality of controlled apparatuses, transferring the remote control signals from a single remote control to multiple controlled apparatuses (one-to-many transfer), from multiple remote controls to a single controlled apparatus (many-to-one transfer), and from multiple remote controls to multiple controlled apparatuses (many-to-many transfer). In particular, the present invention relates to a remote control signal transfer system that passes remote control signals transmitted simultaneously at different locations to the controlled apparatus while preventing interference between those remote control signals.

2. Description of the Related Art

Today, there have been developed and manufactured a great variety of information home apparatuses, such as a television receiver, a video recorder/player, an audio visual apparatus, and such information home apparatuses are in widespread use in homes and other living spaces. Such information apparatuses are basically operated directly by manipulating an interface provided on a main body thereof, such as operation buttons, volume switches, etc. However, most of such information apparatuses support remote control using remote controllers.

In the field of household electrical and electronic apparatuses, such as home electrical appliances, infrared remote control using AM modulation has already been established as a means of remotely inputting operation commands to the appliances. Moreover, in the field of information processing apparatuses, infrared data communication, such as IrDA (Infrared Data Association) and SIRCS (Serial Infrared Remote Control System), are widely adopted as a means of wireless communication between information terminals. Infrared communication systems have advantages of low costs and low power consumption. The infrared communication systems are also advantageous in that they are hardly subject to legal restrictions in most countries.

In recent years, information communications technology has advanced to an extent that home networks that connect information home apparatuses with one another and network-ready audiovisual apparatus are widely used in many homes. For example, DLNA (Digital Living Network Alliance) proposes a network scheme that enables seamless interoperability of electrical appliances so that users can easily and conveniently enjoy content from any of the apparatuses at any place in their home. According to this type of scheme, it does not matter which of the apparatuses in the network possesses any given information, such as an audiovisual content. That is, a user can enjoy a certain content regardless of where the content is stored. For example, the user who is in a certain room is able to use a TV monitor to enjoy a content stored in a video recorder installed in a distant room. This means improved convenience for customers.

There is a problem in that the infrared remote control signal does not reach an apparatus installed in a different room. As one solution to this problem, a method of using a remote control signal transfer device, such as an “AV mouse”, to transfer an infrared command from a certain remote control toward an infrared receiver of another apparatus is coming into common use (see Japanese Patent Laid-open No. 2005-260563, for example). According to this method, a receiver and a transmitter of the remote control are connected with each other via a network, and the remote control signal can be transferred to a distant place to be reproduced thereat. For example, there has been proposed a remote control signal relay device that includes an operation signal reception section and an operation signal transmission section. The operation signal reception section receives an infrared operation signal from a remote control designed for any particular electrical appliance, and transmits data thereof to a network. The operation signal transmission section receives the data from the operation signal reception section via the network, and reconstructs therefrom the original infrared operation signal as transmitted by the remote control (see Japanese Patent Laid-open No. 2003-259464, paragraph 26 and FIG. 3, for example).

The above-described devices that relay or transfer the remote control signal basically presupposes that remote control receiving sections and remote control transmitting sections are typically connected with each other in a one-to-one manner. Therefore, in the case where one device is remotely controlled from two locations, two sets of receivers and transmitters are demanded. In the case where a plurality of devices are remotely controlled from one location, the same number of sets of receivers and transmitters as the number of devices to be controlled are demanded.

In the case where two or more infrared transmitters are pointed at a single controlled apparatus, if infrared receivers that are provided at two different positions receive remote control signals simultaneously, the received remote control signals may interfere with each other, making both the remote control signals ineffective.

### SUMMARY OF THE INVENTION

An advantage of the present invention is to provide an excellent remote control signal transfer system that allows a remote control signal transmitted from a remote control to be appropriately transferred to a controlled apparatus installed at a separate place.

Another advantage of the present invention is to provide an excellent remote control signal transfer system that allows reception of remote control signals from a plurality of remote controls and transfer of the remote control signals to a plurality of controlled apparatuses.

Yet another advantage of the present invention is to provide an excellent remote control signal transfer system that implements, in a system including a plurality of remote controls and a plurality of controlled apparatuses, transfer of remote control signals from a single remote control to multiple controlled apparatuses (one-to-many transfer), from multiple remote controls to a single controlled apparatus (many-to-one transfer), and from multiple remote controls to multiple controlled apparatuses (many-to-many transfer).

Yet another advantage of the present invention is to provide an excellent remote control signal transfer system that makes it possible to pass remote control signals transmitted simultaneously at different places to a controlled apparatus while preventing the remote control signals from interfering with each other.

According to one embodiment of the present invention, there is provided a remote control signal transfer system for transferring a remote control signal sent by a remote control toward a controlled apparatus via a transmission medium, the system including one or more remote control signal reception devices each installed at a separate place from which a user remotely controls one or more controlled apparatuses. The system further includes one or more remote control signal reconstruction devices each installed for a separate one of the one or more controlled apparatuses. Each of the one or more remote control signal reception devices subjects a remote control signal obtained from a remote control receiving section to sampling, and transmits resultant data to the transmission medium to be eventually delivered to one or more of the one or more remote control signal reconstruction devices. Each of the one or more remote control signal reconstruction devices composes the remote control signals received from any one or more of the one or more remote control signal reception devices via the transmission medium into a single composed signal, and outputs the single composed signal to the corresponding controlled apparatus via a single remote control transmitting section.

Note that the term “system” in “remote control signal transfer system” as used herein refers to a logical collection of devices (or function modules that implement specific functions), and it does not manner whether all of the devices or function modules are contained in a single housing.

With a proliferation of home networks and network-ready audiovisual apparatus, an increasing number of people use a TV monitor installed in a certain room to enjoy a content stored in a video recording device installed at a distant room, for example. As a method for achieving remote control of a device installed in a separate room, relay and transfer of remote control signals are coming into common use. In such a method, a remote control receiving section and a remote control transmitting section are connected to each other via a network, and a remote control signal is transferred to a distant place and reproduced.

Related art remote control signal transfer devices, however, basically presuppose that remote control receiving sections and remote control transmitting sections are typically connected with each other in a one-to-one manner. Therefore, the demanded number of remote control signal transfer apparatuses increases in proportion to the number of places from which a user may carry out the remote control or the number of apparatuses that may be remotely controlled. Moreover, the related art remote control signal transfer devices have a problem in that the remote control signals transmitted simultaneously at different places may interfere with each other.

In contrast, the remote control signal transfer system according to one embodiment of the present invention includes one or more remote control signal reception devices and one or more remote control signal reconstruction devices each installed for a separate controlled apparatus, and the remote control signal reception device(s) and the remote control signal reconstruction device(s) are connected via a transmission medium such as a network. Each remote control signal reception devices subjects the signal from the remote control receiving section to sampling, and transmits the resultant data to the network to be eventually delivered to one or more of the remote control signal reconstruction device(s). Each remote control signal reconstruction device composes all remote control signals received from different places via the network into a single composed signal, and transmits the single composed signal to the corresponding controlled apparatus via a single remote control transmitting section.

That is, each remote control signal reception device transfers the remote control signal to the remote control signal reconstruction device(s) via the network without specifying the destination, while each remote control signal reconstruction device composes all the remote control signals transferred from the remote control signal reception devices into the single composed signal and transmits the single composed signal to the corresponding controlled apparatus. Therefore, the transfer of the remote control signals is achieved in any of a one-to-many manner, a many-to-one manner, and a many-to-many manner. Moreover, there is not a need to provide the same number of pairs of remote control signal reception devices and remote control signal reconstruction devices as the number of possible combinations of the places from which the user may carry out the remote control and the apparatuses that may be remotely controlled. Instead, there is only a need to install one remote control signal reception device at each of the places from which the user may carry out the remote control and provide one remote control signal reconstruction device for each of the controlled apparatuses.

The remote control signal transfer system may adopt a pass-through system as a method of transferring the remote control signals. The pass-through system is a system in which a bit sequence, as it is, that is represented by the remote control signal received by the remote control signal reception device is transmitted as data to the network. In this case, the remote control signal reconstruction device is able to compose the remote control signals received via the network into one by superimposing the remote control signals one upon another (i.e., by arranging the bit sequences of the remote control signals on a time axis and implementing the logical OR operation). Even if a large number of remote control signals overlap each other in terms of time, a reception buffer hardly experiences an overflow.

Alternatively, the remote control signal transfer system may adopt a command conversion system as the method of transferring the remote control signals. The command conversion system is a system in which the remote control signal reception device converts the remote control signal into command data before transmitting the data to the network, and the remote control signal reconstruction device converts the received command data again into a remote control signal and outputs it. In this case, the remote control signal reconstruction device can arrange the commands received from the network in sequential order to achieve the composing of the signals while preventing the remote control signals from interfering with each other.

In this case, the remote control signal reconstruction device may, upon receipt of each command via the network, reconstruct a remote control signal from the received command and output the thus-generated remote control signals in sequential order. In the case where some of the received commands are detained in a buffer, for example, the remote control signal reconstruction device may discard some of the commands as necessary.

The remote control signal reconstruction device may assign different priorities to the remote control signals received via the transmission medium. In this case, the some of the commands discarded may be commands having the lowest priorities of all.

In the case where the pass-through system is adopted, the remote control signal reconstruction device may, when superimposing the bit sequences one upon another, carry out a mask process by mask signals with lower priorities with signals with higher priorities. In this case, where two or more remote control signals overlap each other in terms of time, remote control signals with high priorities are not interfered by remote control signal with lower priorities.

According to one embodiment of the present invention, there is provided an excellent remote control signal transfer system that implements, in a system including a plurality of remote controls and a plurality of controlled apparatuses, transfer of the remote control signals in the one-to-many manner, the many-to-one manner, and the many-to-many manner.

According to one embodiment of the present invention, there is also provided an excellent remote control signal transfer system that is able to pass the remote control signals transmitted simultaneously at different places to the controlled apparatus while preventing the remote control signals from interfering with each other.

In the remote control signal transfer system according to one embodiment of the present invention, the transfer of the remote control signals in the one-to-many manner, the many-to-one manner, and the many-to-many manner is achieved without the need to provide the same number of pairs of remote control signal reception devices and remote control signal reconstruction devices as the number of possible combinations of the places from which the user may carry out the remote control and the apparatuses that may be remotely controlled. Instead, there is only a need to install one remote control signal reception device at each of the places from which the user may carry out the remote control and provide one remote control signal reconstruction device for each of the controlled apparatuses. This reduces costs significantly.

In the remote control signal transfer system according to one embodiment of the present invention, even when receiving the remote control signals from a plurality of remote control signal reception devices simultaneously, the remote control signal reconstruction device is able to deliver a remote control signal with a high priority to the corresponding controlled apparatus without fail, by assigning different priorities to the remote control signals.

These and other features and advantages of the present invention will become more apparent from the following detailed description of embodiments of the present invention when taken in conjunction with the accompanying drawings.

### BRIEF DESCRIPTION OF THE DRAWINGS

FIG. 1 is a schematic diagram illustrating an overall configuration of a remote control signal transfer system according to a first embodiment of the present invention;

FIG. 2 is a schematic diagram illustrating a functional structure of an apparatus that operates as a remote control signal reception device;

FIG. 3 is a diagram illustrating a functional structure of a device that operates as a remote control signal reconstruction device in the system as illustrated in FIG. 1;

FIG. 4 illustrates an exemplary operation in a sampling section of a remote control signal reception device;

FIG. 5 illustrates an exemplary operation of a signal composing section of a remote control signal reconstruction device;

FIG. 6 is a diagram illustrating a functional structure of a device that operates as a remote control signal reception device in a remote control signal transfer system according to a second embodiment of the present invention;

FIG. 7 illustrates a functional structure of a device that operates as a remote control signal reconstruction device in the remote control signal transfer system according to the second embodiment;

FIG. 8 illustrates an exemplary operation of a command detection section detecting a command based on a sampling result obtained by a sampling section;

FIG. 9 illustrates an exemplary operation of a signal composing section of the remote control signal reconstruction device;

FIG. 10 illustrates an exemplary operation of a remote control signal reconstruction section of the remote control signal reconstruction device, i.e., an operation of reconstructing a remote control signal from a composed signal;

FIG. 11 is a schematic diagram illustrating an overall configuration of a remote control signal transfer system according to a third embodiment of the present invention;

FIG. 12 is a schematic diagram illustrating an overall configuration of a remote control signal transfer system according to a fifth embodiment of the present invention;

FIG. 13 is a diagram for explaining a process performed by a signal composing section of a remote control signal reconstruction device in a remote control signal transfer system according to a seventh embodiment of the present invention; and

FIG. 14 is a diagram for explaining a process performed by a signal composing section of a remote control signal reconstruction device in a remote control signal transfer system according to an eighth embodiment of the present invention.

### DETAILED DESCRIPTION OF THE PREFERRED EMBODIMENTS

Hereinafter, embodiments of the present invention will be described with reference to the accompanying drawings.

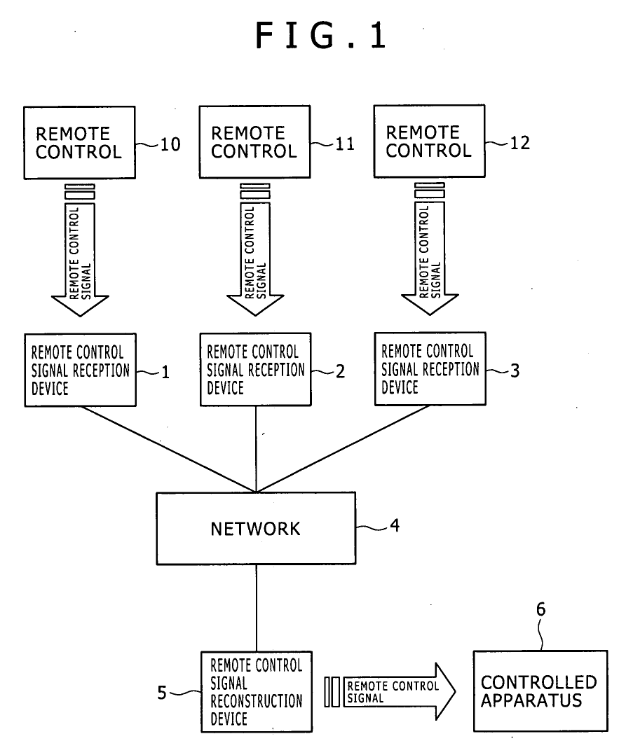

FIG. 1 is a schematic diagram illustrating an overall configuration of a remote control signal transfer system according to a first embodiment of the present invention. This system includes multiple remote control signal reception devices and a single remote control signal reconstruction device, and transfer of remote control signals is performed in a many-to-one manner. In addition, as a method of transferring the remote control signals, a pass-through system is adopted. The pass-through system is a system in which a bit sequence, as it is, that is represented by a remote control signal received by the remote control signal reception device is transmitted as data to a network.

Remote controls 10 to 12 and a controlled apparatus (i.e., an apparatus to be controlled) 6 are located at a distance from one another. A remote control signal from any of the remote controls 10 to 12 may not reach the controlled apparatus 6 directly.

Relative positions of the remote control 10 and a remote control signal reception device 1 are such that a remote control signal from the remote control 10 can reach the remote control signal reception device 1 directly. Similarly, remote control signals from the remote controls 11 and 12 can reach remote control signal reception devices 2 and 3, respectively, directly.

Each of the remote control signal reception devices 1 to 3 is connected to a common network 4. A remote control signal reconstruction device 5 is also connected to the common network 4.

When receiving the remote control signals from their respective remote controls 10 to 12, the remote control signal reception devices 1 to 3 convert the received remote control signals into a format that enables resultant data to be transferred on the network, and send the resultant converted data to the network 4. Then, the data transferred on the network 4 reach the remote control signal reconstruction device 5.

The remote control signal reconstruction device 5 composes the separate pieces of data transferred from the remote control signal reception devices 1 to 3 into a single piece of data to reconstruct a remote control signal therefrom. Then, the remote control signal reconstruction device 5 transmits the reconstructed remote control signal to the controlled apparatus 6 to achieve control of the apparatus 6.

Note that the network 4 may be either a wired or wireless network. Also note that any protocol (data format) may be used on the network as long as the data can reach from the remote control signal reception devices to the remote control signal reconstruction device to reconstruct the remote control signal. The same holds true with the subsequent embodiments as well.

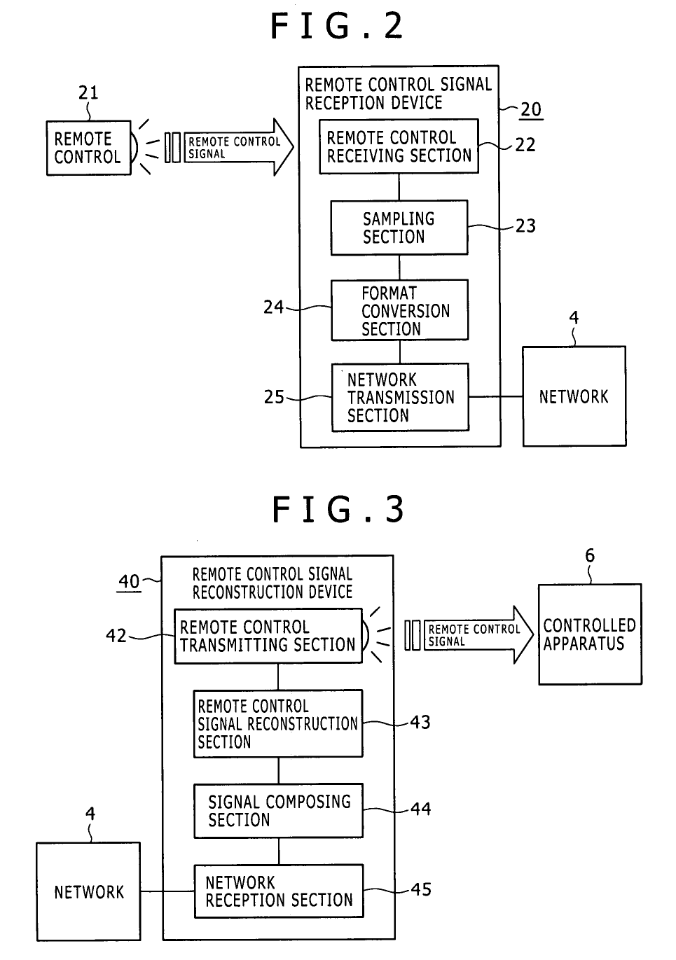

FIG. 2 is a schematic diagram illustrating a functional structure of a device 20 that operates as any of the remote control signal reception devices 1 to 3 in the system as illustrated in FIG. 1. The device 20 includes a remote control receiving section 22, a sampling section 23, a format conversion section 24, and a network transmission section 25. The network transmission section 25 is connected to the network 4.

The remote control receiving section 22 converts flashing on and off of light of a remote control signal transmitted from a remote control 21 into On/Off of an electrical signal. The sampling section 23 takes samples of the On/Off of the electrical signal at a fixed frequency to store data of the samples temporarily. The format conversion section 24 converts the thus stored data into the format that enables the data to be transferred on the network, and sends the resultant data to the network transmission section 25. The network transmission section 25 performs a process of sending the data to all or some of the apparatuses connected to the network 4.

FIG. 3 illustrates a functional structure of a device 40 that operates as the remote control signal reconstruction device in the system as illustrated in FIG. 1. The remote control signal reconstruction device 40 as illustrated in FIG. 3 includes a remote control transmitting section 42, a remote control signal reconstruction section 43, a signal composing section 44, and a network reception section 45. The network reception section 45 is connected to the network 4.

The network reception section 45 receives all remote control signals transmitted from the plurality of remote control signal reception devices and transferred on the network 4, and sends the received remote control signals to the signal composing section 44. The signal composing section 44 performs an arithmetic composing operation on pieces of data transmitted in the same time period to compose the pieces of data into the single piece of data. The details of the composing of the pieces of data will be described later. The remote control signal reconstruction section 43 receives the single composed piece of data and converts it into the On/Off of an electrical signal. Then, the remote control transmitting section 42 converts the On/Off of the electrical signal into the flashing on and off of light for remote control.

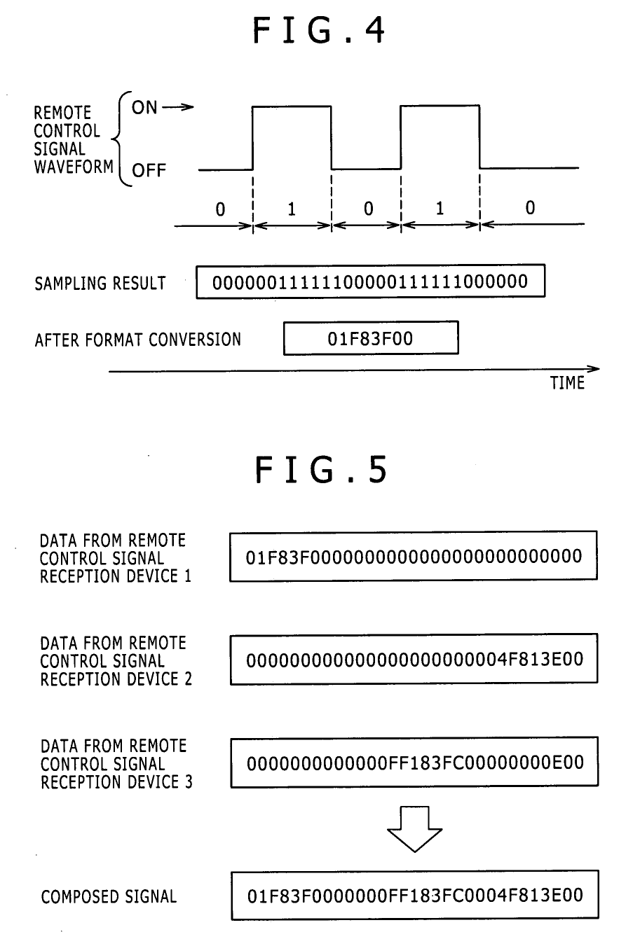

FIG. 4 illustrates an exemplary operation in the sampling section 23 of the remote control signal reception devices 20.

In FIG. 4, a remote control signal waveform represents a waveform of the On/Off of the electrical signal outputted from the remote control receiving section 22. The sampling section 23 subjects the On/Off waveform to sampling at the fixed frequency, and converts each of the samples into a value of 0 or 1 based on comparison of its electrical signal level with a reference level. A result of this conversion corresponds to a bit sequence denoted as “sampling result” in FIG. 4. Thereafter, the bit sequence is, for example, converted into a data sequence in hexadecimal format, which is suitable for data processing, to obtain a format-converted data sequence.

FIG. 5 illustrates an exemplary operation of the signal composing section 44 of the remote control signal reconstruction device 40.

When the plurality of pieces of data that have different signal sources (i.e., have been transmitted from the different remote control signal reception devices 1 to 3) and are judged to have been transmitted in the same time period are obtained from the network reception section 45, the signal composing section 44 performs an arithmetic operation on the pieces of data to obtain a the composed signal, which is constituted by a single piece of data. In the example of FIG. 5, an OR operation is performed on all the received signals.

As described above, in the remote control signal transfer system according to the first embodiment of the present invention, each of the plurality of remote control signal reception devices subjects the signal from the remote control receiving section to sampling, and transmits the resultant data to the single remote control signal reconstruction device via the network without specifying a destination. The remote control signal reconstruction device composes all the remote control signals transmitted from the remote control signal reception devices into the single composed signal to transmit it to the controlled apparatus. In this manner, the transfer of the remote control signals is achieved in the many-to-one manner.

Next, a second embodiment of the present invention will now be described below. A system according to this embodiment has the same overall configuration as illustrated in FIG. 1. Therefore, an illustration thereof is omitted. In the first embodiment, the pass-through system has been adopted that converts the remote control signal into the On/Off of the electrical signal, and transfers, as the remote control signal, the data sequence obtained by the sampling thereof at the fixed frequency. In contrast, the second embodiment adopts a command conversion system. The command conversion system is a system in which the remote control signal received by the remote control signal reception device is converted into a command and the command is transmitted to the network, and the command received by the remote control signal reconstruction device is converted into a remote control signal for use.

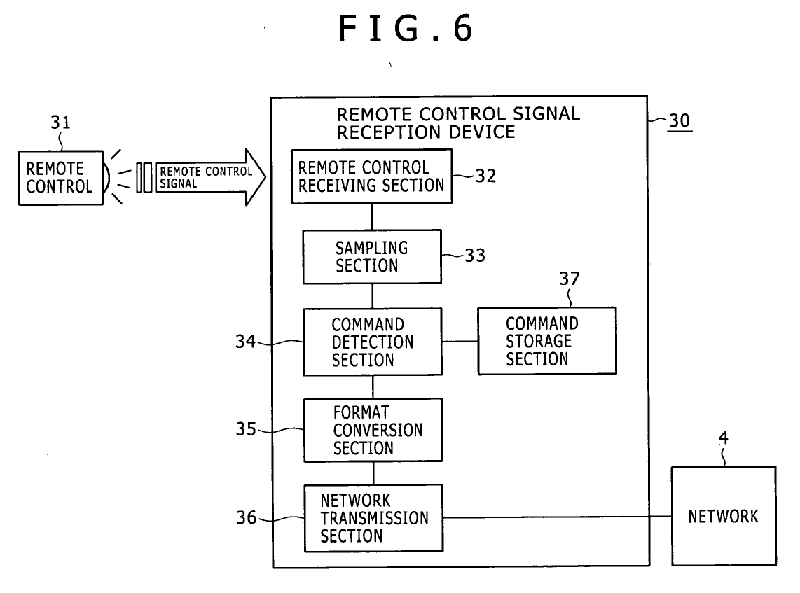

FIG. 6 illustrates a functional structure of a device 30 that operates as the remote control signal reception device in the remote control signal transfer system according to the second embodiment. In FIG. 6, the remote control signal reception device 30 includes a remote control receiving section 32, a sampling section 33, a command detection section 34, a command storage section 37, a format conversion section 35, and a network transmission section 36. The network transmission section 36 is connected to the network 4.

The remote control receiving section 32 converts the flashing on and off of light of a remote control signal transmitted from a remote control 31 into the On/Off of an electrical signal. The sampling section 33 takes samples of the On/Off of the electrical signal at a fixed frequency to store data of the samples temporarily. The command detection section 34 checks whether the thus stored data includes a pattern that corresponds to any command stored in the command storage section 37. If such a pattern is found in the stored data, the pattern is determined to be that command, and the command is sent to the format conversion section 35 as data. The format conversion section 35 converts that data into a format that enables the resultant data to be transferred on the network, and sends the resultant data to the network transmission section 36. The network transmission section 36 performs a process of sending the data to all or some of the apparatuses connected to the network.

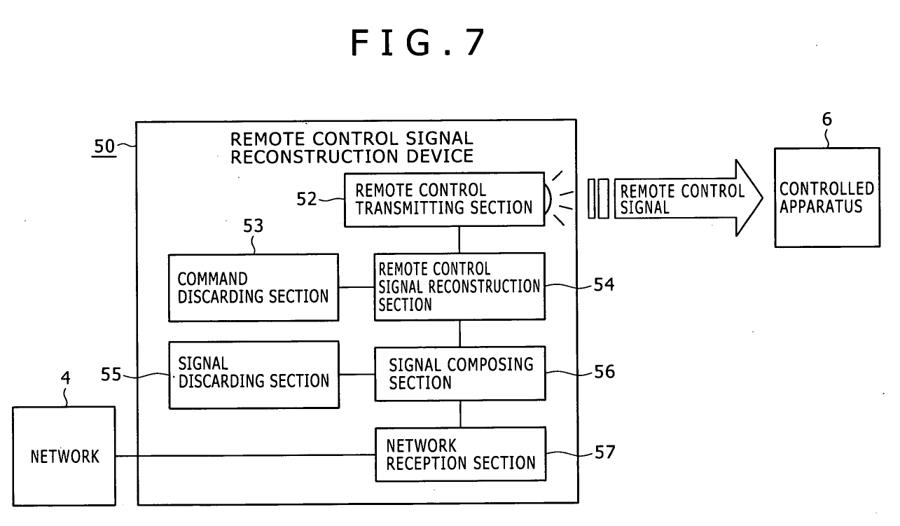

FIG. 7 illustrates a functional structure of a device 50 that operates as the remote control signal reconstruction device in the remote control signal transfer system according to the second embodiment. In FIG. 7, the remote control signal reconstruction device 50 includes a remote control transmitting section 52, a command storage section 53, a remote control signal reconstruction section 54, a command discarding section 55, a signal composing section 56, and a network reception section 57. The network reception section 57 is connected to the network 4.

The network reception section 57 receives all pieces of data transmitted from the plurality of remote control signal reception devices and transferred on the network 4, and sends the received data to the signal composing section 56. The signal composing section 56 arranges the commands received from the different transmission sources in sequential order to compose the commands into a single composed sequence of commands.

In the case where any commands are detained, some of the commands are supplied to the command discarding section 55 as necessary and discarded thereat. In the present embodiment, selection of the commands to be discarded may be carried out in any manner.

Upon receipt of the single composed sequence of commands, the remote control signal reconstruction section 54 converts it into the On/Off of an electrical signal according to signal patterns stored in the command storage section 53. Then, the remote control transmitting section 52 converts the On/Off of the electrical signal into the flashing on and off of light for remote control.

An operation in the sampling section 33 of the remote control signal reception device 30 is the same as the operation described in the first embodiment. Therefore, an explanation thereof is omitted.

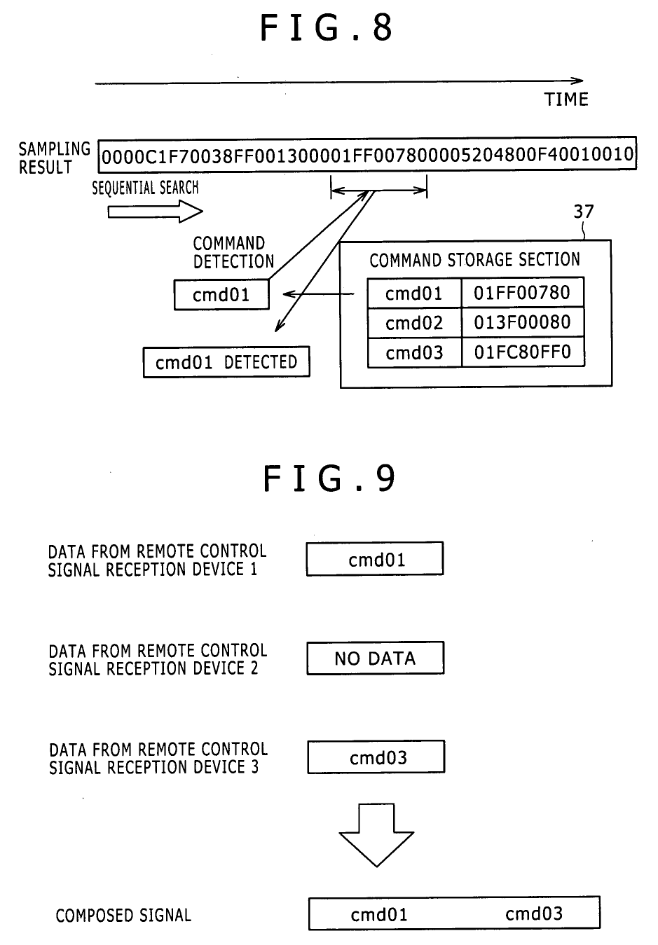

FIG. 8 illustrates an exemplary operation of the command detection section 34 of the remote control signal reception device 30, i.e., an operation of detecting the command based on the sampling result obtained by the sampling section 33.

The command detection section 34 detects, from among the data sequence of the sampling result obtained from the sampling section 33, the pattern that corresponds to any command pattern stored in the command storage section 37, and outputs as data a command number corresponding to the command pattern.

FIG. 9 illustrates an exemplary operation of the signal composing section 56 of the remote control signal reconstruction device 50. Suppose that, as illustrated in FIG. 9, a plurality of pieces of data that have been transmitted from the different sources and which are judged to have been transmitted in the same time period are inputted from the network reception section 57 to the signal composing section 56. Also suppose that the data is inputted on a command-by-command basis, as the command conversion system is adopted in the present embodiment. The signal composing section 56 arranges the input data (i.e., the commands) in sequential order (e.g., in a FIFO manner) to obtain the composed signal. In the case where the amount of the data that have reached the signal composing section 56 exceeds a presupposed permissible amount, some of the data are supplied to the command discarding section 55 as necessary and discarded thereat.

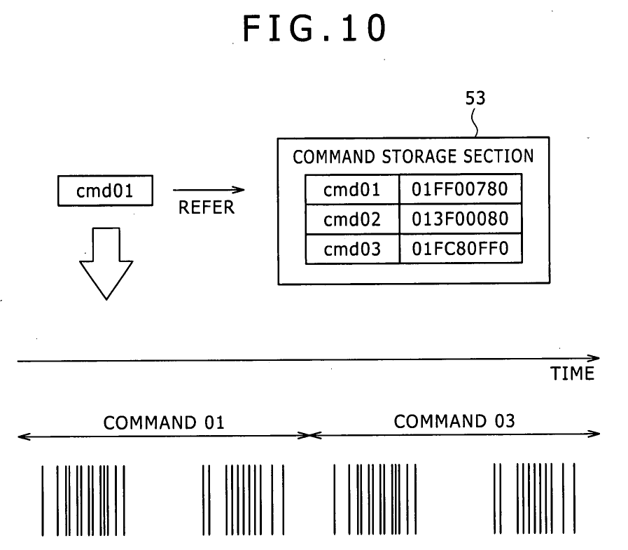

FIG. 10 illustrates an exemplary operation of the remote control signal reconstruction section 54 of the remote control signal reconstruction device 50, i.e., an operation of reconstructing the remote control signal from the single composed signal.

The remote control signal reconstruction section 54 replaces the commands arranged within the composed signal obtained from the signal composing section 56 with their corresponding signal patterns stored in the command storage section 53 sequentially to obtain a reconstructed signal. Note that a part of the composed signal that corresponds to a time period when no signal was received is replaced with a previously prepared signal pattern intended for a no-signal time period.

As described above, in the remote control signal transfer system according to the second embodiment of the present invention, each of the plurality of remote control signal reception devices subjects the signal from the remote control receiving section to sampling, and transmits the resultant data to the single remote control signal reconstruction device via the network without specifying the destination. The remote control signal reconstruction device composes all the remote control signals transferred from the remote control signal reception devices into the single composed signal and transmits it to the controlled apparatus. In this manner, the transfer of the remote control signals is achieved in the many-to-one manner. Moreover, as the command conversion system is adopted for the transfer of the remote control signals, the remote control signal reconstruction device can compose the remote control signals while preventing interference between the signals by arranging the commands received from the network in sequential order.

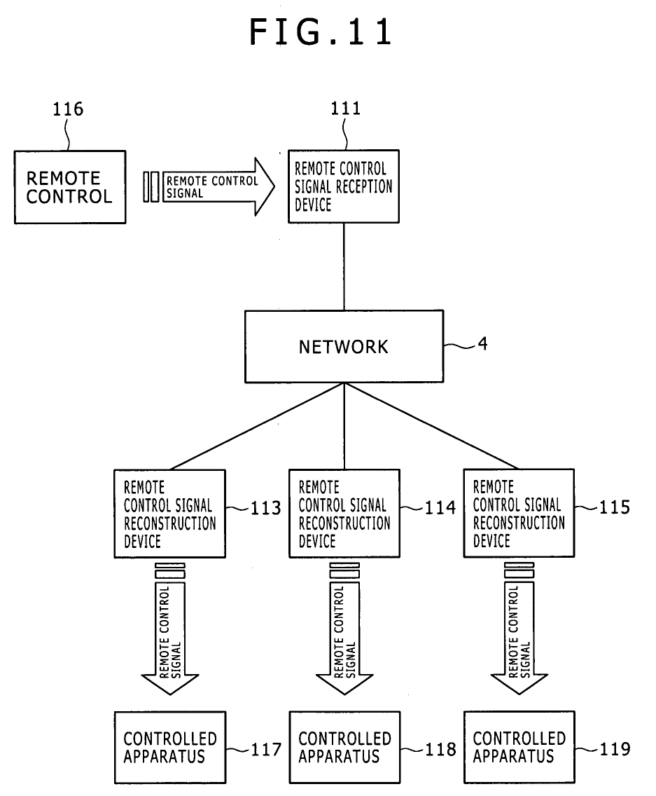

FIG. 11 is a schematic diagram illustrating an overall configuration of a remote control signal transfer system according to a third embodiment of the present invention. The system of FIG. 11 includes a single remote control signal reception device and multiple remote control signal reconstruction devices, and the remote control signals are transferred from the single remote control signal reception device to the multiple remote control signal reconstruction devices (i.e., the transfer of the remote control signals is performed in a one-to-many manner). In addition, as the method of transferring the remote control signals, the pass-through system is adopted. The pass-through system is a system in which a bit sequence, as it is, that is represented by a remote control signal received by the remote control signal reception device is transmitted as data to a network.

A remote control 116 and controlled apparatuses 117 to 119 are located at a distance from one another, so that a remote control signal from the remote control 116 may not reach any of the controlled apparatuses 117 to 119 directly.

Relative positions of the remote control 116 and a remote control signal reception device 111 are such that the remote control signal from the remote control 116 can reach the remote control signal reception device 111 directly. The remote control signal reception device 111 is connected to the common network 4.

Remote control signal reconstruction devices 113 to 115 are connected to the common network 4, and are located so that they can deliver the remote control signal to their respective controlled apparatuses 117 to 119 directly. Note that, although the number of remote control signal reconstruction devices and that of controlled apparatuses are three in this embodiment, the present invention is not limited to this example. The number thereof may be any number greater than one.

Upon receipt of the remote control signal from the remote control 116, the remote control signal reception device 111 converts the remote control signal into the format that enables the resultant data to be transferred on the network, and sends the resultant converted data to the network 4. Then, the data transferred on the network 4 reaches all the remote control signal reconstruction devices 113 to 115.

The remote control signal reconstruction devices 113 to 115 each reconstruct the remote control signal based on the data transferred from the remote control signal reception device 111, and transmit the reconstructed remote control signal to the respective controlled apparatuses 117 to 119 to achieve control of the respective apparatuses 117 to 119.

The structure of a device that is used as the remote control signal reception device 111 according to the present embodiment is the same as that of the remote control signal reception device 20 illustrated in FIG. 2. Therefore, an explanation thereof is omitted. Further, the structure of a device that is used as any of the remote control signal reconstruction devices 113 to 115 is the same as that of the remote control signal reconstruction device 40 illustrated in FIG. 3. Therefore, an explanation thereof is omitted.

In the remote control signal transfer system according to the third embodiment of the present invention, the remote control signal reception device subjects the signal outputted from the remote control receiving section to sampling and transfers the resultant data to the multiple remote control signal reconstruction devices via the network without specifying the destination. Each of the remote control signal reconstruction devices receives the remote control signal transferred from the remote control signal reception device and transmits it to the corresponding controlled apparatus. Thus, the transfer of the remote control signals is achieved in the one-to-many manner.

A remote control signal transfer system according to a fourth embodiment of the present invention includes a single remote control signal reception device and multiple remote control signal reconstruction devices, and adopts the command conversion system as the method of transferring the remote control signals. The system configuration is the same as that illustrated in FIG. 11. The structures of the remote control signal reception device and the remote control signal reconstruction devices are the same as those of the remote control signal reception device 30 of FIG. 6 and the remote control signal reconstruction device 50 of FIG. 7, respectively. Therefore, explanations thereof are omitted.

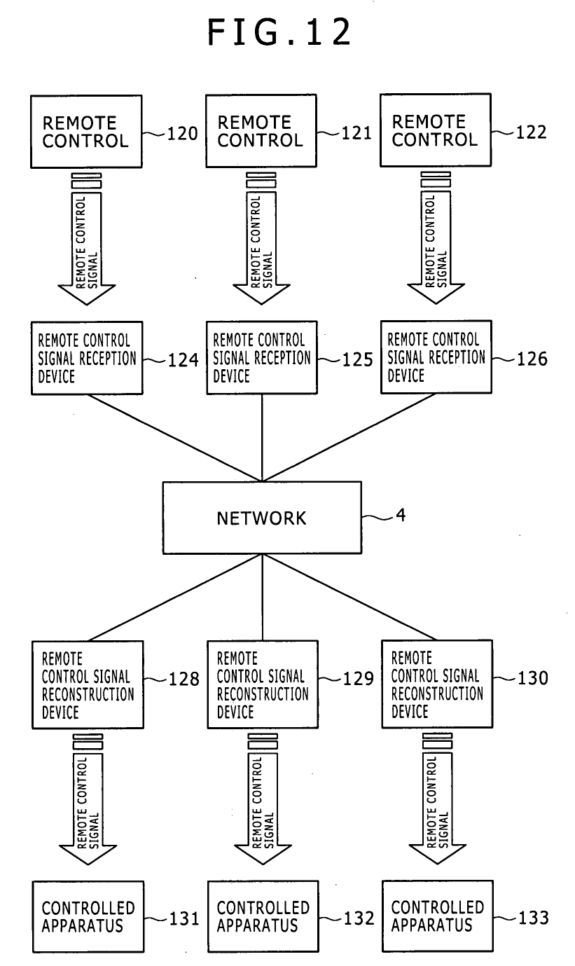

FIG. 12 is a schematic diagram illustrating an overall configuration of a remote control signal transfer system according to a fifth embodiment of the present invention. The system of FIG. 12 includes multiple remote control signal reception devices and multiple remote control signal reconstruction devices, and the remote control signals are transferred from the multiple remote control signal reception devices to the multiple remote control signal reconstruction devices (i.e., the transfer of the remote control signals is performed in a many-to-many manner). Moreover, as the method of transferring the remote control signals, the pass-through system is adopted.

Remote controls 120 to 122 and controlled apparatuses 131 to 133 are located at a distance from one another, so that a remote control signal from any of the remote controls 120 to 122 may not reach any of the controlled apparatuses 131 to 133 directly.

Relative positions of the remote control 120 and a remote control signal reception device 124 are such that the remote control signal from the remote control 120 can reach the remote control signal reception device 124 directly. Similarly, the remote control signal from the remote controls 121 and 122 can directly reach remote control signal reception devices 125 and 126, respectively.

Remote control signal reconstruction devices 128 to 130 are connected to the common network 4 and located so that they can deliver the remote control signal to their respective controlled apparatuses 131 to 133 directly. Note that, although the number of remote controls, that of remote control signal reception devices, that of remote control signal reconstruction devices, and that of controlled apparatuses are three in this embodiment, the present invention is not limited to this example. The number may be any number greater than one.

Upon receipt of the remote control signal from the corresponding one of the remote controls 120 to 122, each of the remote control signal reception devices 124 to 126 converts the remote control signal into the format that enables the resultant data to be transferred on the network, and sends the resultant converted data to the network 4. Then, the data transferred on the network 4 reaches all the remote control signal reconstruction devices 128 to 130.

Each of the remote control signal reconstruction devices 128 to 130 arranges the pieces of data transferred from the remote control signal reception devices 124 to 126 in sequential order to reconstruct the remote control signal, and transmits the reconstructed remote control signal to the corresponding one of the controlled apparatuses 131 to 133 to achieve simultaneous control of the apparatuses 131 to 133. Thus, the remote control is achieved in the many-to-many manner.

The structure of a device that is used as any of the remote control signal reception devices 124 to 126 in the present embodiment is the same as that of the remote control signal reception device 20 illustrated in FIG. 2. Therefore, an explanation thereof is omitted. The structure of a device that is used as any of the remote control signal reconstruction devices 128 to 130 is the same as that of the remote control signal reconstruction device 40 illustrated in FIG. 3. Therefore, an explanation thereof is omitted.

In the remote control signal transfer system according to the fifth embodiment of the present invention, each of the plurality of remote control signal reception devices subjects the signal outputted from the remote control receiving section to sampling and transfers the resultant data to the plurality of remote control signal reconstruction devices via the network without specifying the destination. Each of the remote control signal reconstruction devices composes all the remote control signals transferred from the remote control signal reception devices into the single composed signal and transmits the composed signal to the corresponding one of the controlled apparatuses. Thus, the transfer of the remote control signals is achieved in the many-to-many manner.

A remote control signal transfer system according to a sixth embodiment of the present invention includes multiple remote control signal reception devices and multiple remote control signal reconstruction devices, and adopts the command conversion system as the method of transferring the remote control signals. The system configuration thereof is the same as that illustrated in FIG. 12. The structures of the remote control signal reception device and the remote control signal reconstruction device are the same as those of the remote control signal reception device 30 of FIG. 6 and the remote control signal reconstruction device 50 of FIG. 7, respectively. Therefore, explanations thereof are omitted.

A remote control signal transfer system according to a seventh embodiment of the present invention includes multiple remote control signal reception devices and a single remote control signal reconstruction device, and adopts the pass-through system as the method of transferring the remote control signals. In the seventh embodiment, the composing of the remote control signals in the remote control signal reconstruction device involves assigning different priorities to the remote control signals. The system configuration is the same as that illustrated in FIG. 1. The structure of each of the remote control signal reception devices is the same as that of the remote control signal reception device 20 illustrated in FIG. 2. Therefore, explanations thereof are omitted.

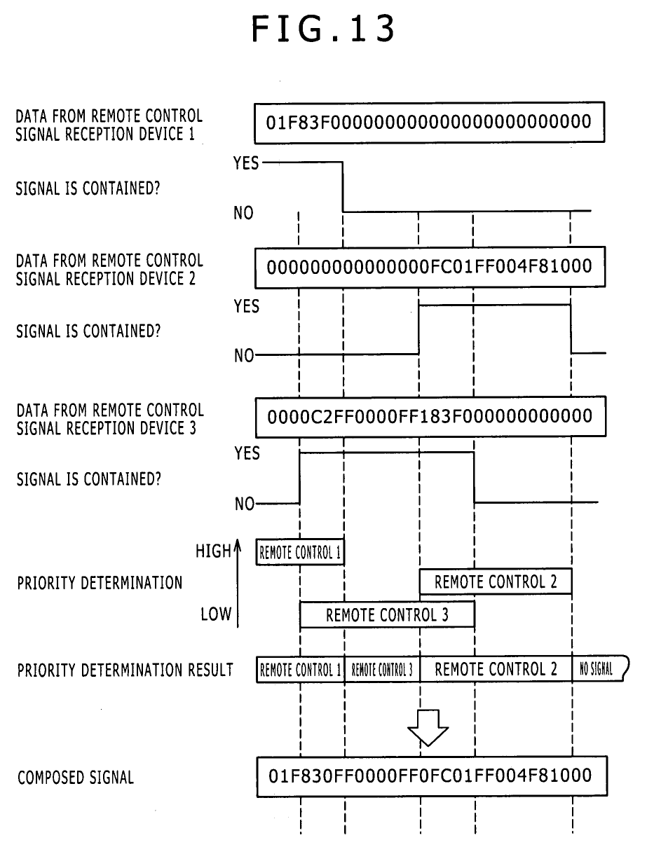

The structure of the remote control signal reconstruction device according to the present embodiment is similar to that of the remote control signal reconstruction device 40 illustrated in FIG. 3. However, a process performed in the signal composing section is different from that described above in reference to the first embodiment. Therefore, the process will now be described below with reference to FIG. 13.

First, each of the pieces of data sent from the remote control signal reception devices 1 to 3 is analyzed to determine which parts of the data contain a signal and which parts of the data do not contain a signal.

Next, those parts of each of the pieces of data which have been determined to contain a signal are subjected to priority determination. In the priority determination, such parts of the data are assigned with different priorities. The priority determination is carried out as a preparation for masking parts of the data with lower priorities with parts of the data with higher priorities.

As a result, a priority determination result is obtained in which the parts of the data with lower priorities are masked with the parts of the data with higher priorities.

Based on the priority determination result, the pieces of data sent from the remote control signal reception devices 1 to 3 are composed into a single piece of data, i.e., a composed signal that prevents data with lower priorities from interfering with data with higher priorities.

A remote control signal transfer system according to an eighth embodiment of the present invention includes multiple remote control signal reception devices and a single remote control signal reconstruction device, and adopts the command conversion system as the method of transferring the remote control signals. In the eighth embodiment, discarding of commands involves assigning different priorities to the remote control signals received by the remote control signal reconstruction device. The system configuration is the same as that of FIG. 1. The structure of each remote control signal reception device is the same as that of the remote control signal reception device 30 illustrated in FIG. 6. Therefore, explanations thereof are omitted.

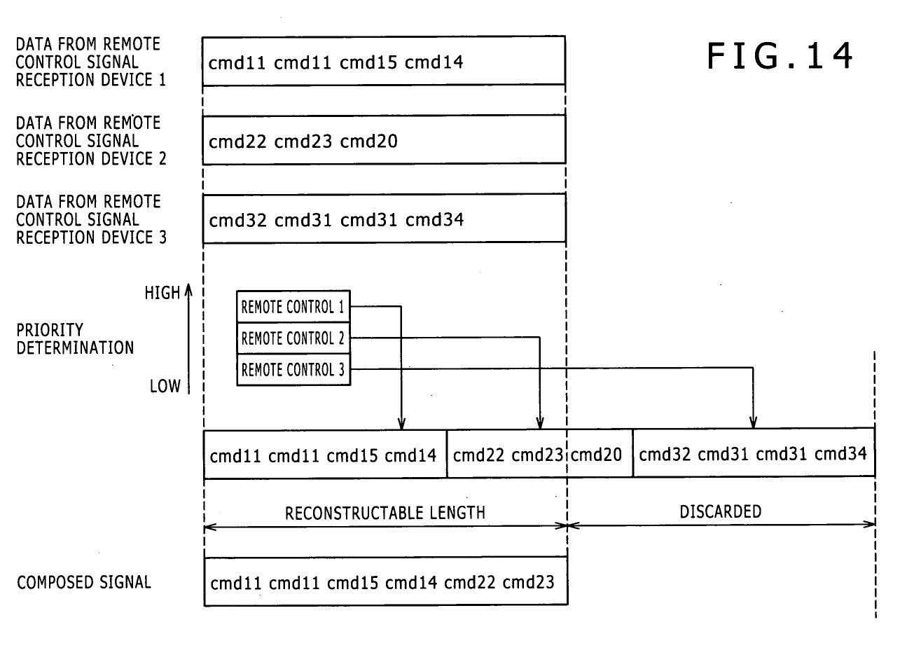

The structure of the remote control signal reconstruction device is similar to that of the remote control signal reconstruction device 50 illustrated in FIG. 7. However, a process performed in the signal composing section is different from that described above in reference to the second embodiment. The process will now be described below with reference to FIG. 14.

The signal composing section performs the priority determination with respect to the pieces of data sent from the remote control signal reception devices, and arranges sequences of commands sent from the respective remote control signal reception devices in descending order of priority.

Then, if the resultant data sequence is longer than a predetermined maximum length (i.e., a reconstructable length) that allows the reconstruction of the remote control signal from the data sequence, a low-priority part of the data sequence that is beyond the reconstructable length is supplied to the command discarding section and discarded thereat. This results in a single composed signal that prevents data with lower priorities from interfering with data with higher priorities.

As described above, in the seventh and eighth embodiments of the present invention, even if a plurality of remote control signals are transferred from a plurality of remote control signal reception devices simultaneously, the remote control signal reconstruction device is able to ensure delivery of a high-priority remote control signal to the controlled apparatus by assigning proper priorities to the remote control signals.

While the present invention has been described in detail above with reference to the specific embodiments, the foregoing description is in all embodiments illustrative and not restrictive. It should be understood by those skilled in the art that various modifications, combinations, sub-combinations and alterations may occur depending on design requirements and other factors insofar as they are within the scope of the appended claims or the equivalents thereof.

What is claimed is:

1. A remote control signal transfer system for transferring a remote control signal sent by a remote control toward a controlled apparatus via a transmission medium, the system comprising:
one or more remote control signal reception devices each installed at a separate place from which a user remotely controls one or more controlled apparatuses; and
one or more remote control signal reconstruction devices each installed for a separate one of the one or more controlled apparatuses, wherein
each of said one or more remote control signal reception devices subjects a remote control signal obtained from a remote control receiving section to sampling, and transmits resultant data to the transmission medium to be eventually delivered to one or more of said one or more remote control signal reconstruction devices, and
each of said one or more remote control signal reconstruction devices composes the remote control signals received from any one or more of said one or more remote control signal reception devices via the transmission medium into a single composed signal, and outputs the single composed signal to the corresponding controlled apparatus via a single remote control transmitting section.

2. The remote control signal transfer system according to claim 1, wherein
the data transmitted by each of said one or more remote control signal reception devices to the transmission medium is a bit sequence, as it is, that is represented by the remote control signal received, and
the single composed signal transmitted as a remote control signal by each of said one or more remote control signal reconstruction devices is the bit sequence of the data received via the transmission medium.

3. The remote control signal transfer system according to claim 2, wherein each of said one or more remote control signal reconstruction devices generates the single composed signal by superimposing the bit sequences represented by the remote control signals received via the transmission medium one upon another.

4. The remote control signal transfer system according to claim 1, wherein
each of said one or more remote control signal reception devices converts the remote control signal into command data before transmitting the data to the transmission medium, and
each of said one or more remote control signal reconstruction devices converts the received command data again into the remote control signal before transmitting the single composed signal toward the controlled apparatus.

5. The remote control signal transfer system according to claim 4, wherein each of said one or more remote control signal reconstruction devices generates the single composed signal by converting each of a plurality of pieces of said command data into the remote control signal upon receipt, and outputting the resultant remote control signals in sequential order.

6. The remote control signal transfer system according to claim 5, wherein each of said one or more remote control signal reconstruction devices discards some of the plurality of pieces of received command data as necessary.

7. The remote control signal transfer system according to claim 6, wherein
each of said one or more remote control signal reconstruction devices assigns different priorities to the plurality of pieces of received command data, and
the some of the plurality of pieces of received command data discarded have lowest priorities.

8. The remote control signal transfer system according to claim 4, wherein each of said one or more remote control signal reconstruction devices converts each of a plurality of pieces of said received command data again into the remote control signal, and transmits the generated single composed signal by superimposing bit sequences represented by the remote control signals one upon another.

9. The remote control signal transfer system according to claim 8, wherein
each of said one or more remote control signal reconstruction devices assigns different priorities to the plurality of pieces of received command data, and
superimposition of the bit sequences is performed such that a bit sequence corresponding to command data with a lower priority is masked with a bit sequence corresponding to command data with a higher priority.

10. A remote control signal reception device that operates in the remote control signal transfer system according to claim 1, the device comprising:
a remote control receiving section configured to convert flashing on and off of light of a remote control signal transmitted from a remote control into On/Off of an electrical signal;
a sampling section configured to take samples of the On/Off of the electrical signal at a fixed frequency;
a command detection section configured to detect a command pattern that corresponds to a command from data of the samples taken by said sampling section;
a format conversion section configured to convert the detected command pattern into data in a format that allows the data to be transferred on a network; and
a data transmission section configured to transmit the data toward all or some of apparatuses connected to the transmission medium.

11. A remote control signal reconstruction device that operates in the remote control signal transfer system according to claim 1, the device comprising:
a data reception section configured to receive a remote control signal transmitted from one or more remote control signal reception devices via the transmission medium;
a signal composing section configured to compose two or more pieces of data transmitted in the same time period from the one or more remote control signal reception devices into a single composed piece of data based on a priority determination result in which parts of the data with lower priorities are masked with parts of the data with higher priorities;
a remote control signal reconstruction section configured to convert the single composed piece of data into On/Off of an electrical signal; and
a remote control transmitting section configured to convert the On/Off of the electrical signal into flashing on and off of light for remote control.

12. A remote control signal reconstruction device that operates in the remote control signal transfer system according to claim 1, the device comprising:
a data reception section configured to receive data transmitted from one or more remote control signal reception devices via the transmission medium, the data being a command obtained by conversion of a remote control signal by the one or more remote control signal reception devices;
a signal composing section configured to arrange the commands transmitted from the one or more remote control signal reception devices in sequential order to compose the commands into a single command sequence;
a command discarding section configured to discard, as necessary, a part of the single command sequence that is detained;
a remote control signal reconstruction section configured to convert each of the commands within the single command sequence into On/Off of an electrical signal according to a corresponding signal pattern; and
a remote control transmitting section configured to convert the On/Off of the electrical signal into flashing on and off of light for remote control.

13. The remote control signal reconstruction device according to claim 12, wherein,
said signal composing section performs a priority determination with respect to the data transmitted from the one or more remote control signal reception devices, and arranges the commands in descending order of priority to generate the single command sequence, and
said command discarding section discards a part of the single command sequence that is beyond a predetermined reconstructable length.
